(19) United States
(12) Patent Application Publication
(10) Pub. No.: US 2026/0023429 A1
(43) Pub. Date: Jan. 22, 2026

(54) METHOD FOR CONTROLLING A COMPUTER BY MEANS OF AN EYE TRACKING CAMERA, COMPUTER-READABLE STORAGE MEDIUM AND SYSTEM

(71) Applicant: Curly Cube GmbH, Stuttgart (DE)

(72) Inventors: Kolja Böger, Düsseldorf (DE); Tom Brehm, Stuttgart (DE)

(21) Appl. No.: 19/269,292

(22) Filed: Jul. 15, 2025

(30) Foreign Application Priority Data
Jul. 16, 2024 (DE) 102024120208.4

(51) Int. Cl. G06F 3/01

(52) U.S. Cl. CPC G06F 3/013

(57) ABSTRACT

The invention relates to a method for controlling a computer, in particular tablet computer, by means of an eye tracking camera. The invention further relates to a corresponding computer-readable storage medium as well as a corresponding system for carrying out the method.
A method for controlling a computer, in particular tablet computer (21), by means of an eye tracking camera (22), wherein the method has the following steps:
   a) capturing a first gaze position (13) in a screen area (10) by means of the eye tracking camera (22);
   b) generating a first control command, which prompts the computer to control a pointer icon to a target position, which corresponds to the first gaze position (13);
   c) capturing a second gaze position (13′) in an action area (11A-G) by means of the eye tracking camera (22), wherein the action area (11A-G) lies outside the screen area (11) and is assigned to an action type; and
   d) generating a second control command, which prompts the computer to perform an action as a function of the target position and/or the action type.

### DESCRIPTION

The invention relates to a method for controlling a computer, in particular a tablet computer, by means of an eye tracking camera. The invention further relates to a corresponding computer-readable storage medium as well as a corresponding system for carrying out the method.

People who are unable to speak and move due to extensive motor skill limitations (e.g., due to ALS or infantile cerebral palsy), often use special devices for a supported communication. In particular commercially available tablet computers can be used for this purpose, the functionality of which is expanded and adapted to the particular needs of the users by means of additional hardware and/or special applications for a supported communication.

It is in particular known to use conventional tablet computers as communication aids, wherein the operation takes place by means of eye control. For this purpose, a tablet computer is equipped with an eye tracking camera, which captures the gaze position of the user and provides it to the tablet computer via an input interface. An application or a component of the operating system of the tablet computer itself, which is installed on the tablet computer, then controls a pointer icon on the graphic user interface according to the captured gaze position of the user.

In order to operate conventional graphic user interfaces, however, not only the control of the pointer position is often required but also the triggering of an action, e.g., left or right click, double click, etc., at a specified pointer position, after the pointer icon was controlled to the desired position.

In order to be able to perform these actions by means of eye control, software applications are known, h are installed on the operating system of the computer and which superimpose the graphic user interface of the computer with additional buttons and display elements. In order to open, for example, a folder on a desktop view, the user can, in each case by means of eye control, select the corresponding action type (e.g., double click) as one of the additional buttons and can subsequently control the cursor to the desired position.

However, this approach is not compatible with all conventional computer operating systems because some operating systems do not permit the manipulation of the graphic user interface by means of additional software, for example, the above-described superimposition.

It is thus the object of the present invention to specify an improved method for controlling a computer by means of an eye tracking camera. The method is to in particular also be applicable for computer operating systems, which do not permit interventions in their graphic user interface by means of additional software, at least not a superimposition of the user interface for the display of additional buttons. The method is to in particular further provide for an intuitive operation for the users, so that operating errors of the computer can be reduced.

This object is solved by means of a method according to claim 1, a computer-readable storage medium according to claim 12 as well as by means of a system according to claim 13.

The object is solved in particular by means of a method for controlling a computer, in particular a tablet computer, by means of an eye tracking camera. The computer thereby has a graphic user interface, which can be operated by positioning a pointer icon and/or triggering an action when the pointer icon is positioned, and the method has the following steps:
a) capturing a first gaze position in a screen area by means of the eye tracking camera;
b) generating a first control command, which prompts the computer to control the pointer icon to a target position, which corresponds to the first gaze position, and sending the control command to the computer;
c) capturing a second gaze position in an action area by means of the eye tracking camera, wherein the action area lies outside the screen area and is assigned to an action type; and
d) generating a second control command, which prompts the computer to perform an action as a function of the target position and/or the action type, and sending the second control command to the computer.

In the context of the present invention, a screen area can be understood to be an area, in which the screen of the computer is arranged. An action area can be understood to be any area in the field of vision of the user, to which an action type (e.g., left click, right click, double click, etc.) is assigned with regard to the computer operating system. Action areas can in particular be arranged on a frame, which surrounds the computer screen. According to the invention, action areas serve as virtual buttons, which can be selected by means of eye control, even though they are arranged outside the screen area.

It is an aspect of the method according to the invention that the input desired by the user (i.e., the action and optionally the corresponding cursor position) is captured in that
a first gaze position is initially captured in a screen area; and then
a second gaze position is captured in an action area, which is arranged outside the screen area.

After capturing the first gaze position, a (first) control command is generated and is sent to the computer, wherein the first control command prompts the computer to control the pointer icon to the corresponding target position. After capturing the second gaze position, a (second) control command is generated and is sent to the computer, wherein the second control command prompts the computer to perform an action as a function of the previously captured target position and/or the action type of the action area.

By capturing gaze positions according to the invention not only in the screen area but also in the action areas, the interaction surface for the user can be expanded. The action area can in particular serve as virtual button, by means of which the user can intuitively trigger actions, such as left or right click, at previously determined cursor positions by means of eye control, without a corresponding button having to be integrated into the graphic user interface of the computer operating system by means of additional software.

The method according to the invention is thus in particular suitable for the use in computers, the operating systems of which prohibit far-reaching interventions in the graphic user interface, as long as the operating system accepts the generated first and second control commands.

It is not required thereby that the method is carried out by the computer operating system itself, as long as it is ensured that the gaze position can be received by the eye tracking camera and control commands can be sent to the computer. For example, the method can be carried out as part of the firmware of the eye tracking camera, in particular in combination with computer systems, such as, e.g., iPads, which do not permit any (additional) software, which continuously runs in the background.

Carrying out the method according to the invention as part of the firmware of the eye tracking camera can include that not only basic control signals are sent to the computer, such as, e.g., mouse left click and mouse right click, but also more complex signals, such as, e.g., a touchpad double tap with three simulated finger positions, in order to trigger the desired actions, such as, e.g., a zoom operating aid, in the computer operating system. The modified firmware of the eye tracking camera, which carries out the method according to the invention, can also carry out a temporarily modified handling or modification of the gaze position captured by the eye tracking camera, such as, e.g., a conversion of the gaze position coordinates captured by the eye tracking camera for a zoom range.

The method according to the invention furthermore allows controlling the computer in an intuitive manner because, for actions, which are to be performed at a certain pointer position, the user initially controls the pointer icon to a target position and then selects the action type, which is to be performed for the target position.

In one embodiment, the action area is one of several action areas, which are arranged above and/or below and/or laterally of the screen area.

As already explained, the interaction surface for the user can be expanded in this way in that action areas are (at least partly) arranged around the screen area. One action area can in particular in each case be provided for the following action types: left click, right click, double click, zoom.

Alternatively or additionally to the above-mentioned action types, which are performed as a function of a pointer icon position, action areas can also be provided for action types, which are performed independently of a pointer icon position, for example: accessing a home screen, opening an application, etc.

An action type can furthermore be an up/down scrolling. A window area, in which the scrolling is to be carried out, can thereby further be specified by means of the pointer icon position.

In a further embodiment, the method further has the following steps:
generating a (further) control command, which prompts the computer to control the pointer icon to the target position and/or to hold it there, in particular independently of a current gaze position; and
sending the (further) control command, in particular repeatedly, in particular as long as the current gaze position lies outside the screen area.

The mentioned steps can in particular be performed after step b) and prior to step c).

According to this embodiment, it can be ensured that an (unwanted) change of the pointer position is prevented, which could be created in that the user moves his/her gaze away from the target position and towards the action area.

For this purpose, the embodiment provides to generate at least one further control command and to send it to the computer, which control command prompts the computer to maintain the target position (captured in step a)) as pointer icon position, even if the current gaze position deviates therefrom. In other words, it is simulated by means of generating and sending the further control command that the current gaze position is still the gaze position captured in step a), so that the pointer icon position remains unchanged.

In a further embodiment, the method further comprises at least one of the following steps, in particular between step b) and c):
capturing a dwell time of a gaze position at the target position;
confirming the gaze position when the dwell time exceeds at least a first time period, in particular 2000 ms; and
highlighting the target position in the graphic user interface, in particular by displaying a graphic element and/or controlling the pointer icon for carrying out a confirmation movement when the gaze position has been confirmed.

This embodiment makes it possible for the user, after the pointer icon was controlled to the target position by means of the first control command in step b), to confirm or fix or “lock”, respectively, the previously selected target position by means of prolonged focusing. It is captured for this purpose whether the gaze position of the user has lingered at the target position (or an area around the target position, respectively), for at least the length of the first time period.

By highlighting the target position in the graphic user interface, the user obtains a feedback that the gaze position confirmed by him/her has been detected by the system.

The highlighting of the target position in the graphic user interface can in particular comprise the sending of a control command to the computer, which prompts the computer to display a graphic element and/or to control the pointer icon so that it moves according to a specified confirmation movement. The confirmation movement of the pointer icon can be, for example, a continuous movement on a circle, which is defined with a radius of a few pixels (e.g., 5 pixels, preferably 2 pixels) around the target position. However, the confirmation movement of the pointer icon can also be given by executing any other specified movement path, so that the pointer icon makes, for example, a jumping movement as confirmation movement.

Making a confirmation movement of the pointer icon in reaction to the confirmation of the gaze position is particularly advantageous insofar as this process only requires a control of the pointer icon position, but not control commands for the display or manipulation of additional graphic elements. This option is thus suitable in particular for computers, the operating systems of which do not permit such manipulations or controls of their graphic user interface.

This embodiment can in particular be combined with the above-described embodiment, so that it is ensured immediately after the described fixation of the pointer icon position by means of the generation of further control commands that the change of the gaze position—from the screen surface to the action area outside the screen surface—does not effect any unwanted change of the pointer icon position.

In a further embodiment, step d) comprises the capturing of a gaze position in a region of the action area for a second time period. The second time period is preferably shorter than the first time period, for example 200 ms.

According to this embodiment, the virtual button, which corresponds to the action area, is selected by means of prolonged focusing, similarly to the above-described fixation of the gaze position. The dwell time (=second dwell time) required for this purpose is preferably shorter than the dwell time for the fixation of the pointer icon position (=first dwell time).

Due to the action areas, which are comparatively large compared to the screen resolution, the selection of the action area (i.e., of the virtual button) by means of gaze focusing in the case of the eye control requires a less high precision than the determination of the target position. If the user thus already holds his/her gaze on the action area for a short dwell time, this can he considered to be a reliable indicator for the fact that the user wants to in fact select the action area.

In that, according to this embodiment, different dwell times can be provided for the respective gaze focusings, a high input speed can be achieved on the one hand and incorrect inputs can be reduced on the other hand.

In a further embodiment, the action type is at least one of the following action types: mouse left click, mouse right click, scrolling, zoom in, zoom out.

The actions known from conventional user interfaces, which can be operated by means of a mouse or a similar input device, can be triggered in this way.

Based on the basic types of the above-mentioned action types, different actin modes are conceivable, which are optimized with regard to the operation via eye control.

The action type, which is linked to a certain action area, can be adapted dynamically. For example, action areas for scrolling can trigger a respective faster or further scrolling, respectively, in response to consecutive triggering.

For example, two pairs of scrolling action surfaces can furthermore be present, one for a left screen area and one for a right screen area.

If only one scrollable window area exists in the graphic user interface in this case because, for example, an application is maximized over the entire screen surface, the scrolling is carried out for this one window area, independently of whether a button of the scrolling action surfaces is deselected for the left screen area or the right screen area.

If several scrollable window areas exist, for example when an email application is active, in which a scrollable list of the e-mails is displayed in a left window area and a scrollable display of the selected email is displayed in a right window area, it is thus generally defined on the basis of the fixed or confirmed pointer position, respectively, in which of the two window areas the scrolling is to be carried out.

However, the second control command can also be generated so that a scrolling in the corresponding screen area takes place even without confirmed fixed or pointer position, respectively (a scrolling in a left screen area takes place by selecting the left scrolling action, a scrolling in a right screen area takes place by selecting the right scrolling action surfaces). A confirmed target position is simulated for this purpose by means of specified standard target positions.

Standard target positions can be specifed either on the basis of absolute positions on the screen surface or can be determined dynamically, in particular as a function of an application, which is currently displayed on the screen surface.

The action types linked to the action areas can be a function of an application, which is currently used on the computer. In the case of an active web browser, a pair of action areas can, for example, be assigned to the action types “navigate forwards” and “navigate backwards”, and can be assigned to the action types “increase volume” and “decrease volume” in the case of an active media player.

The assignment of action areas to action types can be configured by a user.

One action type can be assigned to an action, which is performed independently of a cursor position, for example:
display OS desktop;
display start menu;
display Windows task switcher (Alt-Tab);
display the on-screen keyboard for the input of text into the operating system;
display the on-screen keyboard for the direct communication;
trigger a pause function.

On the other hand, one action type can be assigned to an action, which is to be performed as a function of a cursor position, for example:
mouse click
zoom into a (small) area around the target position and displaying the area on the entire screen surface, wherein a conversion of the gaze position coordinates, which are captured by the eye tracking camera, is carried out in this area;
continuous zoom; and
drag and drop.

The action type “continuous zoom” can be realized in that a zoom action surface is triggered initially and a different action surface (left click, right click, double click or drag and drop button) is triggered subsequently. A search into the target point is thereby performed continuously and the selected action (e.g., left click etc.) is performed in the end.

The action type drag and drop can be realized in that a drag and drop mode is started in that the confirmation of a target position is captured as described above, then a focusing on a drag and drop action area and lastly the renewed focusing on the previously confirmed target position. In the drag and drop mode, the method “simulates” a pressed mouse button during the drag and drop movement, for example in the case of a left click action. The drag and drop mode can be ended when a dwelling within an area for a specified time period around the new shifted target position is captured.

A smoothing filter is preferably applied to the coordinates, which are captured by the eye tracking camera, during a drag and drop movement when the left mouse button, which continuously follows the current gaze point, is pressed in a simulated manner. In particular, an average of the coordinates, which have been captured during a time interval in the past (e.g., the last 300 ms) can, for this purpose, be calculated, so that the movement can be stabilized. A straight or evenly curved movement, respectively, of the pointer icon is thus created, even if the original gaze point coordinates shake and jump during the movement.

The controlled drawing with freehand tools in drawing programs is also made possible by means of the above-described application of a smoothing filter, with any length of a stroke/drag and drop movement.

In a further embodiment, the method further comprises a determining as to whether the action type is permissible for the target position, and the second control command prompts the computer
to perform the action type at the target position when the action type is permissible for the target position; and
to perform a modified action, optionally as a function of the target position, if the action type is not permissible for the target position.

If, for example, the action type “left click” is not available for a certain target position, the second control command can be generated so that a different action type is performed (e.g., right click) or the computer is prompted to display a corresponding message when focusing on an action area, to which the action type “left click” is assigned.

In a further embodiment, the action type is in particular a mouse left click, mouse right click or mouse double click and the action type for the confirmed target position is performed in step d) as the action, when the confirmation of the target position has been detected.

In a further embodiment, the action type is a zoom, i.e., an enlargement of a (small) area, which is displayed on the screen (hereinafter referred to as “zoom range”).

When the confirmation of the target position has been detected, the zoom is thereby performed in step d) as the action in a zoom range around the confirmed target position. This comprises the display of the zoom range on the entire screen surface, wherein gaze position coordinates captured by the eye tracking camera are converted for the zoom range.

According to this embodiment, a conventional zoom functionality, which the computer operating system provides as operating aid function, can be used in the context of the method according to the invention to control a computer, even though conventional zoom functions are not designed for the control by means of an eye tracking camera.

This is made possible in that the method sends a gesture for activating the zoom functionality to the computer via corresponding control commands (e.g., simulated touchpad double tap with three simulated finger positions, which are defined on the basis of a current gaze position). This prompts the computer to display the zoom range on the entire screen surface. A coordinate transformation is carried out in this state, during which the gaze position, which is captured by the eye tracking camera and which refers to the coordinate system of the enlarged zoom range, is converted into a coordinate system of the screen surface. This coordinate transformation makes it possible that the user can navigate into the enlarged zoom range.

The generation and sending of the activation gesture as well as the coordinate transformation are thereby carried out as part of the proposed method, which can in particular be carried out as part of a firmware run on the eye tracking camera.

In a further embodiment, the action type is a scrolling, and the scrolling is performed in step d) as the action for a window area, which is determined by a specified standard target position.

In a further embodiment, the action is performed independently of the target position in step d).

In a further embodiment, the method further comprises an activating of a status display, in particular of an LED element, which is assigned to the action area, and/or an activating of the computer for highlighting an action area region on the screen area, which is assigned to the action area, namely
a) as soon as a gaze position was captured in the action area; and/or
b) as soon as the second control command was sent to the computer.

In the case of a plurality of action areas, a separate status display can in particular be assigned to each action area. The status display can frame, for example, the respective action area as rectangular or ellipsoidal frame.

According to this embodiment, the user receives an optical feedback about the input process. According to the above option a), the status display is activated as soon as a gaze position in the action area was captured, i.e., at the beginning of the expiration of the second time period. According to option b), the status display can alternatively or additionally be activated as soon as the second control command has been sent to the computer, i.e., essentially after expiration of the second time period. Both options, in particular in combination, make it easier for the user to track the progress of his/her operating process, so that the risk of operating errors can be prevented.

The activation of the status display can cause, for example, a light-up and/or a flashing of the status display.

The status display can further be activated so that it continuously increases the brightness or presents itself in the form of an advancing progress bar, in order to proportionately display the progress of the second dwell time.

An arrangement of the status display (e.g., LED) in the area of the action area assigned to it is particularly advantageous thereby because the status display thus lies directly in the field of vision of the user at the point in time, in which the user directs his/her gaze at the action area (i.e., selects the virtual button). The user thus does not have to direct his/her gaze away from the action area and towards a different position, in order to determine if the operating process was successful.

Alternatively or additionally to activate the status display, an acoustic feedback can be generated by activating an audio output interface, a feedback by means of vibration, etc., in order to inform the user about the event.

Alternatively or additionally to activating an (external) display element, the computer itself can be activated, so that an action area region on the screen area is activated, which is assigned to the action area.

This variation does not require any physical status displays, for example as part of the screen, but uses the computer screen itself as display surface.

The action area region can in particular be arranged on the screen surface in the edge area of the screen surface, so that it adjoins the corresponding action area. The action area region on the screen surface can essentially be, for example, as large as the corresponding action area. It is advantageous to select the action area region on the screen area in the immediate vicinity of the action area because the user can perceive the visual highlighting on the screen in this way while focusing on the action surface.

The object is further solved by means of a computer-readable storage medium. The computer-readable storage medium includes instructions, which prompt at least one processor to implement the method as described above when the instructions are executed by means of the at least one processor.

Similar advantages and technical features, as they have been described in combination with the method according to the invention, result for the computer-readable storage medium.

The object is further solved by means of a system, which has the following:
a computer with screen, in particular tablet computer;
an eye tracking camera; and
a holder, in and/or on which the screen and the eye tracking camera are arranged and on which one or several action areas are arranged,
wherein the system is formed to carry out the method as described above.

On the one hand, the holder can thus serve the purpose of fastening the eye tracking camara to the computer. On the other hand, the holder can serve the purpose of providing the surface for the action areas, i.e., the virtual buttons outside the screen area. For this purpose, the holder can have, for example, a frame, which can in particular be 2 to 8 cm wide and which can enclose the screen of the computer. The action areas can be arranged and optically delimited on the frame, in particular by means of corresponding markings, other colors, etc.

On its rear side, the holder can have a receiving area for a fastening, in order to be able to fasten the system to a wheelchair, table or a stand. This simplifies the arrangement of the system in particular for users, who use the system while sitting in a wheelchair.

Similar advantages and technical effects, as they have been described in combination with the method according to the invention, result for the system.

In one embodiment of the system, the eye tracking camera is formed to carry out the method as described above. For this purpose, a firmware run on the eye tracking camera can be modified accordingly.

This has the technical advantage that neither additional software has to be installed on the operating system of the computer in order to carry out the method according to the invention nor that an additional processing device has to be provided for this purpose. The existing eye tracking camera is instead used as processing device, which sends the corresponding control commands to the computer. An installation of additional software is thus not required on the computer.

In one embodiment, the holder has one or several status displays, in particular LED elements, which are in each case assigned to an action area.

The one or several status displays of the holder can be connected to the tablet computer, in particular via cable or Bluetooth and can be controlled by a software installed on the tablet computer. Alternatively or additionally, status displays can be connected to the eye tracking camera, in particular via cable or Bluetooth, and can be controlled by the firmware of the eye tracking camera.

As already explained, the activation of the status displays, as it has been described in connection with the method, can make it easier for the user to track the progress of the input process.

It is noted at this point that the features and the advantages, which can in each case be attained therewith and which have been described with regard to the method according to the invention, can be applied or transferred, respectively, to the system and the computer-readable storage medium according to the invention, and vice versa. In the context of the present description of the invention, the components of the system are formed concretely to perform the method steps according to the invention. The functions of the above-described components of the system according to the invention can likewise be used as method steps of the method according to the invention.

The invention will be described below on the basis of exemplary embodiments, which are explained in more detail on the basis of the images, in which:

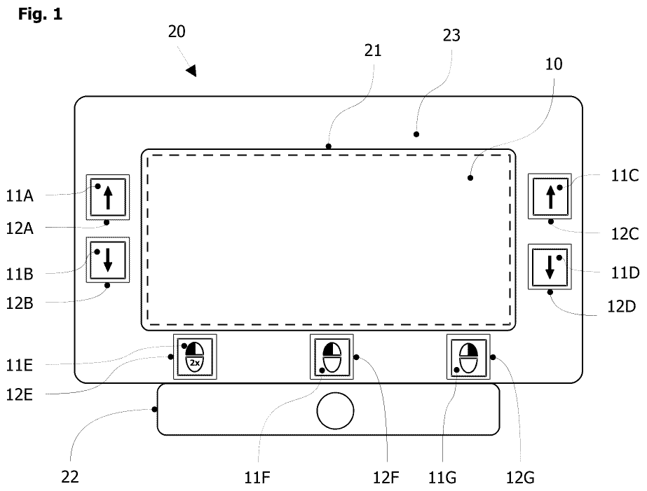

FIG. 1 shows a system according to the invention according to an exemplary embodiment; and

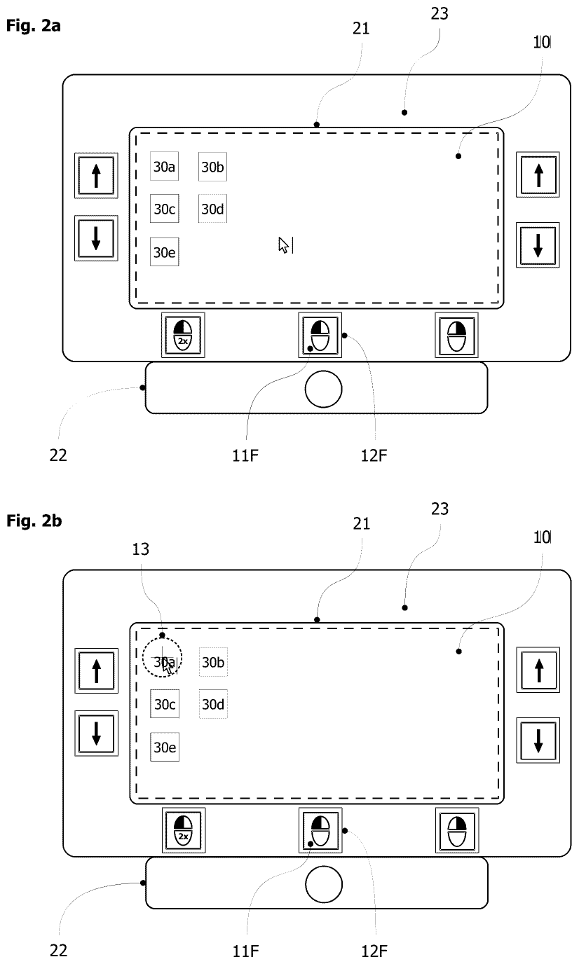

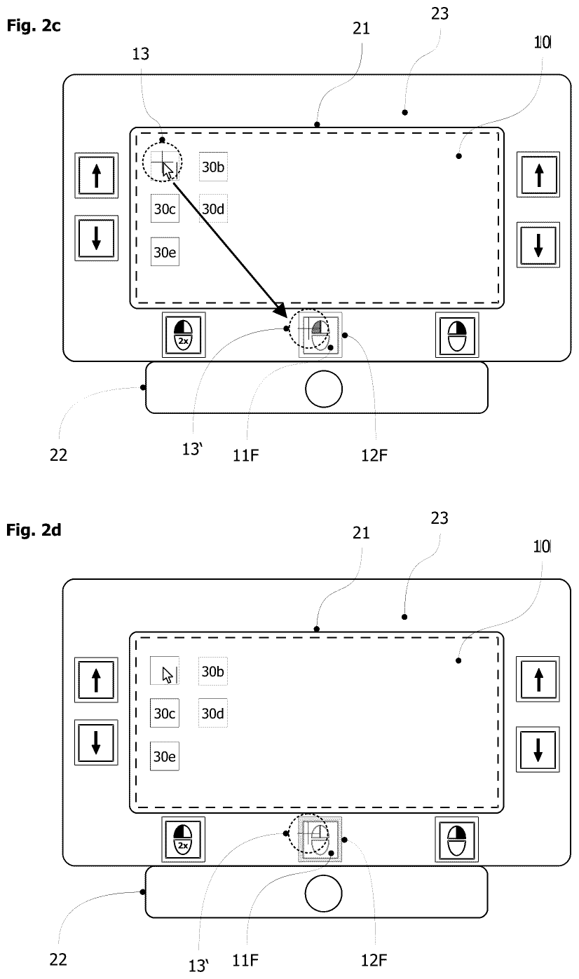

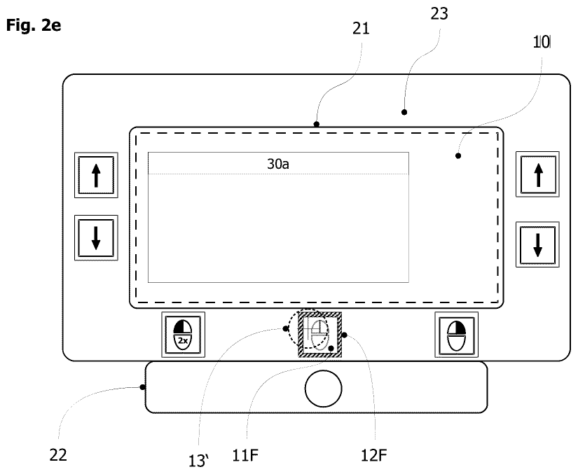

FIG. 2a-e show an input process according to the method according to the invention according to a further exemplary embodiment;

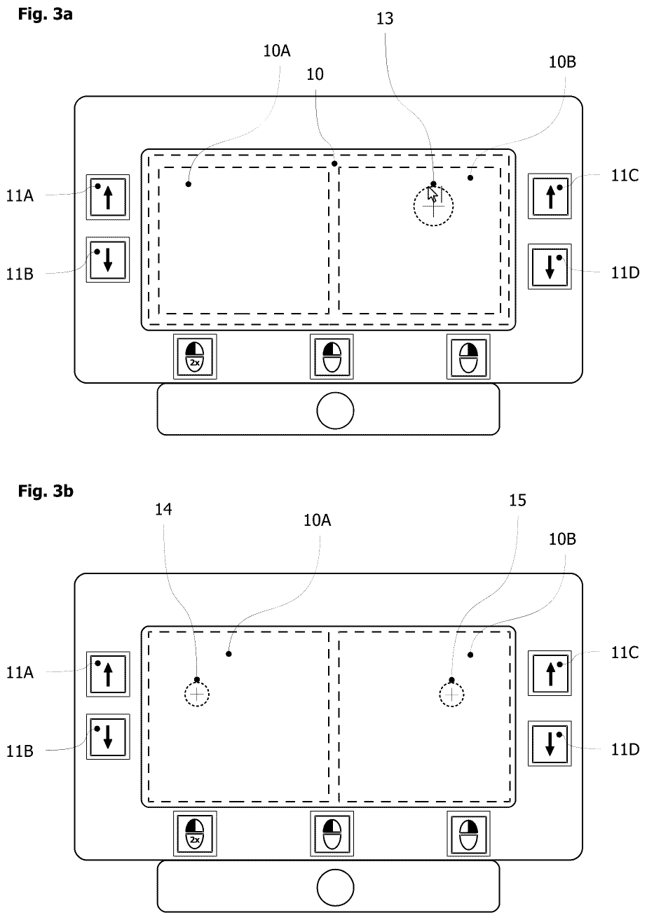

FIG. 3a-b show an input process using scrolling buttons according to a further exemplary embodiment;

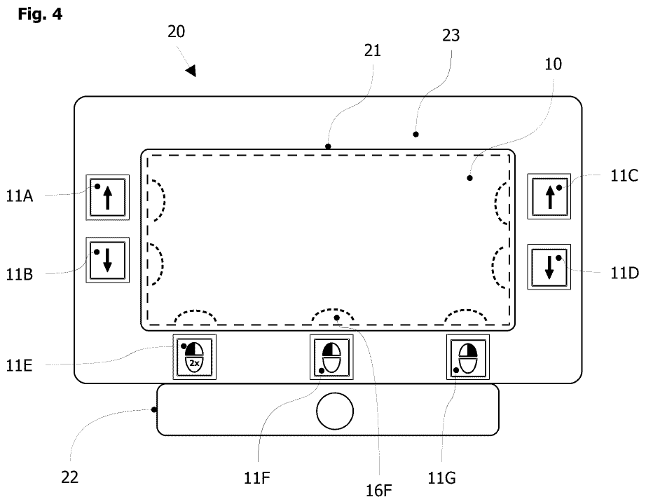

FIG. 4 shows action area regions on the screen surface for the visual highlighting according to a further exemplary embodiment of the method according to the invention.

The same reference numerals are used in the following description for identical and identically acting parts.

FIG. 1 shows a system 20 according to the invention, which has the tablet computer 21, the eye tracking camera 22 and the holder 23.

The tablet computer 21 is arranged in the holder 23 so that a screen area 10 of the tablet computer 21 is enclosed by the holder 23 from the top, bottom, left and right. The eye tracking camera 22 is also arranged at a lower area of the holder 23 and is aligned so that it can capture the gaze position of a user, who looks at the screen area 10.

The eye tracking camera 22 is communicatively connected to the tablet computer 21, for example via a USB-C interface or wirelessly. A processing unit integrated into the eye tracking camera 22 is further formed to carry out the method according to the invention, i.e., to in particular capture the gaze position of the user and to send corresponding control commands to the tablet computer 21.

Several action areas 11A-G are arranged on the frame of the holder 23, which surrounds the screen area 10. The delimitations of the action areas 11A-G on the holder 23 are optically recognizable for the user.

According to the invention, the action areas 11A-G function as virtual buttons for respective action types linked thereto, which the user can select by means of eye control and which can be recognized by means of corresponding pictograms or labels. Concretely, the following action types are assigned to the action areas 11A-G of the exemplary embodiment described here:
action area 11A: first scrolling up
action area 11B: first scrolling down
action area 11C: second scrolling up
action area 11D: second scrolling down
action area 11E: double click left
action area 11F: left click
action area 11G: right click

For example, a scrollable area, which is displayed in the left area of a graphic user interface, can be assigned to the first scrolling (action areas 11A-11B), while a scrollable area, which is displayed in the right area of the graphic user interface, can be assigned to the second scrolling (action areas 11C-11D). The actions linked to the action areas 11A-11B and 11C-11D can thereby be dynamically generated so that repeated activating of the same scrolling action surface triggers a scrolling over a larger distance (i.e., performs a “faster” scrolling of the respective scrollable area).

Each of the action areas 11A to 11G is surrounded by a respective LED element 12A to 12G, which, according to the method according to the invention, is activated during the input process. For example, the LED element 12F can be controlled so that it lights up as soon as and as long as the eye tracking camara 22 detects that the gaze position of the user lies in the action area 11F, and flashes as soon as a (second) control command was generated, which prompts the tablet computer 21 to perform the action (left click) linked to the action area 12F.

The FIGS. 2a to 2e show an input process according to the method according to the invention, in particular using the system illustrated in FIG. 1, according to a further exemplary embodiment.

FIG. 2a hereby shows an initial state, in which a graphic user interface with several folders 30a to 30e is illustrated on the screen of the tablet computer 21. In order to open one of the folders 30a to 30e, it is required to move the pointer icon into the area of the respective folder icon and to trigger a left click at this pointer position.

FIG. 2b shows a state after the eye tracking camera 22 has captured that the gaze position 13 of the user in the area of the folder 30a lies on the screen area 10 and has generated a (first) control command and sent it to the tablet computer 21. As illustrated in FIG. 2b, the first control command has prompted the tablet computer 21 to control the pointer icon to the target position, i.e., the gaze position 13 or the area of the folder 30a, respectively.

It is captured at that point in time, whether the user maintains his/her gaze position for at least the first time period (e.g., 2000 ms) in the area of the gaze position 13. The pointer icon position is fixed in this case and the input process is continued as described in connection with FIGS. 2c to 2e. Otherwise, the pointer icon position is updated according to the captured gaze position.

FIG. 2c shows a successor state, immediately after the pointer icon position was fixed in the area of the folder 30a, as described in connection with FIG. 2b. Even though the user directs his/her gaze from the (first) gaze position 13 towards the (second) gaze position 13′ in the area of the action area 11F in this state (as illustrated by means of the arrow between the gaze positions 13 and 13′), and his/her gaze wanders over other areas of the screen area 10 thereby, the pointer icon position remains unchanged. This is ensured according to the invention in that, starting at the state shown in FIG. 2b, one or several further control commands are generated and are sent to the tablet computer 21, which prompts said tablet computer to hold the pointer icon at the previous location, independently of the current gaze position.

As illustrated in FIG. 2d, the LED element 12F arranged around the action area 11F lights up as soon as the gaze position 13′ in the area of the action area 11F was captured. A further time measurement begins at that point in time, in order to determine whether the user holds his/her gaze in the action area 11F for at least the second time period (e.g., 500 ms).

Lastly, FIG. 2e shows the state after the user has held his/her gaze on the action area 12F for the second time period, starting at the state shown in FIG. 2d. According to the invention, a second control command was generated and was sent to the tablet computer 21, which prompts the latter to carry out a left click with regard to the previously defined pointer icon position (i.e., in the area of the folder 30a). In order to display the successful selection of the action area 11F to the user, the LED element 12F is activated so that it flashes once, immediately after the second time period has expired. With regard to the previously fixed pointer icon position, the left click triggered in this way has the effect that the folder 30a is opened in the illustrated graphic surface (see screen area 10 of FIG. 2e).

FIG. 3a-b shows an input process using scrolling buttons according to a further exemplary embodiment.

In the shown exemplary embodiment, an application with two screen areas 10A and 10B, which can be scrolled separately, is displayed on the screen area 10 of the computer. As in the exemplary embodiments of FIGS. 1 and 2, the shown device has two pairs of scrolling buttons 11A, 11B and 11C, 11D, which have the below-described functionality, as a function of the state.

FIG. 3a shows a state, in which the gaze position 13 has been confirmed by means of prolonged focusing and the pointer icon has been controlled to the corresponding target position in the right window area 10B. In such a state, the action areas 11A-B for the first scrolling as well as for the action areas 11C-11D for the second scrolling are configured so that a scrolling is carried out in the window area 10B, in which the confirmed target position is located.

FIG. 3b, in contrast, shows a state, in which the pointer icon is in fact arranged on the screen surface but a confirmation of the gaze or target position, respectively, is not at hand. The functionality of the scrolling action areas 11A-B or 11C-D, respectively, instead of the (non-confirmed pointer position) is determined by means of the respective standard target positions 14, 15 here.

Concretely, the second control command is generated in such a way when selecting the action areas 11A-B for the first scrolling that a scrolling is carried out with respect to the standard target position 14, i.e., a scrolling in the left screen area 10A.

When selecting the action areas 11C-D for the second scrolling, the second control command is generated accordingly in such a way that a scrolling is carried out with respect to the standard target position 15, i.e., a scrolling in the right screen area 10B.

FIG. 4 shows action area regions on the screen surface for the visual highlighting according to a further exemplary embodiment of the method according to the invention. The action area regions serve for the visual highlighting of a selected action surface and thus fulfill a similar function as the LED elements 12A-G in the exemplary embodiment of FIG. 1, namely the visualization of the input progress for the user.

The action area region 16F is in particular assigned to the action area 11F (left mouse click). The action area region 16F is arranged in the edge area of the screen area 10, has a semi-ellipsoidal shape and a width, which essentially corresponds to the width of the action area 11F.

According to this exemplary embodiment, the method controls the computer so that the action area region 16F is visually highlighted in the graphic user interface when the eye tracking camera captures that the user focusses on the action area 11F. The visual highlighting can in particular comprise a progressive light-up of the action area region 16F, while the user focusses on the action area 11F and the latter has not been triggered yet (i.e., during expiration of the minimum dwell time) and/or a short light-up when the action surface 11F has been triggered (i.e., after expiration of the minimum dwell time).

As illustrated in FIG. 4, corresponding semi-ellipsoidal action area regions (without reference numerals) are likewise assigned to the action areas 11A-E and 11G. They are activated in connection with the corresponding action areas 11A-E and 11G in the manner as it has been described in connection with the action area 11F and the action area region 16F.

The above-described exemplary embodiments are to only be understood in an exemplary manner and a large variety of alternative designs are possible, without deviating from the nature of the invention. Reference is made in an exemplary manner to the following aspects:
Even though a system 20 with a holder 23, which encloses the tablet computer 21 on all four sides (top, bottom, right and left), is described in the exemplary embodiment of FIG. 1, holders are also conceivable, which enclose a screen only on one, two or three sides.

It further goes without saying that instead of the action areas 11A-11G illustrated in FIG. 1, additional or fewer action areas can be arranged, optionally in other arrangement on the holder, as well as action areas for other action types, which can optionally also be embodied independently of a pointer position (e.g., opening an application).

In the system described in FIG. 1, the eye tracking camera is described as external camera, which is connected to the tablet computer. However, it can instead also be a camera, which is integrated in the tablet computer.

It should be noted at this point that all of the above-described parts, in each case on their own-also without features, which are additionally described in the respective context, even if they have not been explicitly identified individually as optional features in the respective context, e.g., by means of the use of: in particular, preferably, for example, e.g., optionally, round brackets, etc.—and in combination or any subcombination, are to be considered to be independent designs or further developments of the invention, respectively, as it is defined in particular in the introductory description as well as the claims. Deviations therefrom are possible. It should be noted concretely that the word in particular or round brackets do not characterize any features, which are mandatory in the respective context.

### LIST OF REFERENCE NUMERALS

10 screen area
11A action area (first scrolling up)
11B action area (first scrolling down)
11C action area (second scrolling up)
11D action area (second scrolling down)
11E action area (double click left)
11F action area (left click)
11G action area (right click)
12A-12G LED elements
13 first gaze position
13′ second gaze position
14, 15 standard positions for defining scrollable screen areas
16F action area region on the screen area (for action area 11F)
20 system
21 tablet computer
22 eye tracking camera
23 holder

1. A method for controlling a computer, in particular tablet computer (21), by means of an eye tracking camera (22),
wherein the computer has a graphic user interface, which can be operated by positioning a pointer icon and/or triggering an action when the pointer icon is positioned,
wherein the method has the following steps:
a) capturing a first gaze position (13) in a screen area (10) by means of the eye tracking camera (22);
b) generating a first control command, which prompts the computer to control the pointer icon to a target position, which corresponds to the first gaze position (13), and sending the control command to the computer;
c) capturing a second gaze position (13′) in an action area (11A-G) by means of the eye tracking camera (22), wherein the action area (11A-G) lies outside the screen area (11) and is assigned to an action type; and
d) generating a second control command, which prompts the computer to perform an action as a function of the target position and/or the action type, and sending the second control command to the computer.

2. The method according to claim 1,
wherein the action area (11A-G) is one of several action areas (11A-G), which are arranged above and/or below and/or laterally of the screen area (10).

3. The method according to claim 1,
which further comprises the following steps:
generating a control command, which prompts the computer to control the pointer icon to the target position and/or to hold it there, in particular independently of a current gaze position; and
sending the control command, in particular repeatedly, in particular as long as the current gaze position lies outside the screen area (10).

4. The method according to claim 1,
which further comprises at least one of the following steps, in particular between step b) and c):
capturing a dwell time of a gaze position (13) at the target position;
confirming the gaze position (13) when the dwell time exceeds at least a first time period, in particular 2000 ms; and
highlighting the target position in the graphic user interface, in particular by displaying a graphic element and/or controlling the pointer icon for carrying out a confirmation movement when the gaze position (13) has been confirmed.

5. The method according to claim 1,
wherein step d) comprises the capturing of a gaze position (13′) in a region of the action area (11A-G) for a second time period, which is preferably shorter than the first time period, in particular for at least 200 ms.

6. The method according to claim 1,
which further comprises a determining as to whether the action type is permissible for the target position, and
wherein the second control command prompts the computer
to perform the action type at the target position when the action type is permissible for the target position; and
to perform a modified action, optionally as a function of the target position, if the action type is not permissible for the target position.

7. The method according to claim 1,
wherein the action type is in particular a mouse left click, mouse right click or mouse double click and
wherein the action type for the confirmed target position is performed in step d) as the action, when the confirmation of the target position has been detected.

8. The method according to claim 1,
wherein the action type is a zoom, and
wherein, when the confirmation of the target position has been detected, the zoom is performed in step d) as the action in a zoom range around the confirmed target position, wherein the zoom range is displayed on the entire screen surface, and gaze position coordinates captured by the eye tracking camera are converted for the zoom range.

9. The method according to claim 1,
wherein the action type is a scrolling, and
the scrolling is performed in step d) as the action for a window area, which is determined by a specified standard target position.

10. The method according to claim 1,
wherein the action is performed independently of the target position in step d).

11. The method according to claim 1,
which comprises an activating of a status display, in particular of an LED element (12A-G), which is assigned to the action area (11A-G),
and/or an activating of the computer for highlighting an action area region (16F) on the screen area (10), which is assigned to the action area (11A-11G), namely
as soon as a gaze position (13′) was captured in the action area (11A-G); and/or
as soon as the second control command was sent to the computer.

12. A computer-readable storage medium, which includes instructions, which prompt at least one processor to implement the method according to claim 1 when the instructions are executed by means of the at least one processor.

13. A system (20), which has the following:
a computer with screen, in particular tablet computer (21);
an eye tracking camera (22); and
a holder (23), in and/or on which the screen and the eye tracking camera (22) are arranged,
wherein the system is formed to carry out the method according to claim 1.

14. A system (20), which has the following:
a computer with screen, in particular tablet computer (21);
an eye tracking camera (22); and
a holder (23), in and/or on which the screen and the eye tracking camera (22) are arranged,
wherein the eye tracking camera (22), in particular a firmware implemented on the eye tracking camera (22), is formed to carry out the method according to claim 1.

15. The system according to claim 13,
wherein the holder (23) has one or several status displays, in particular LED elements (12A-G), which are in each case assigned to an action area.

16. The system according to claim 14,
wherein the holder (23) has one or several status displays, in particular LED elements (12A-G), which are in each case assigned to an action area.
